(19) United States
(12) Patent Application Publication
(10) Pub. No.: US 2026/0244751 A1
(43) Pub. Date: Aug. 20, 2026

(54) STORAGE MEDIUM STORING PROGRAM, CONTROL METHOD, AND INFORMATION PROCESSING APPARATUS

(71) Applicant: CANON KABUSHIKI KAISHA, Tokyo (JP)

(72) Inventor: TATSURO UCHIDA, Kanagawa (JP)

(21) Appl. No.: 19/533,398

(22) Filed: Feb. 9, 2026

(30) Foreign Application Priority Data
Feb. 18, 2025 (JP) 2025-024048

(51) Int. Cl. G06F 21/57; G06F 21/60

(52) U.S. Cl. CPC G06F 21/572; G06F 21/602

(57) ABSTRACT

Ａ program installs, in a computer, a control driver that controls a peripheral device communicably connected to the computer, and has attached thereto a digital signature and certificate data that certifies validity of the digital signature. The certificate data is acquired, and it is determined whether or not the same certificate data already exists in the computer, and whether or not a certificate having issuer information concerning the same issuer as an issuer of the acquired certificate data already exists in the computer. A confirmation screen for prompting a user to confirm whether or not to install the control driver is not displayed if the same certificate data does not exist, and a certificate having the issuer information exists, whereas displayed if the former does not exist, and the latter does not exist.

### BACKGROUND

### Field of the Technology

The present disclosure relates to a storage medium storing a program, a control method, and an information processing apparatus.

### DESCRIPTION OF THE RELATED ART

As a representative print control program that controls a printer, there is, for example, a printer driver of Windows (registered trademark). A driver set of the printer driver of Windows includes a catalog file (CAT file). To the catalog file, a digital signature can be attached to prevent alteration of the driver (see Japanese Laid-Open Patent Publication (Kokai) No. 2014-48956). The “digital signature” is data generated by encrypting a hash value of a driver (file), to which the signature is attached, with a secret key, and is capable of certifying that the driver has not been altered. Further, a certificate is attached to the digital signature. By decrypting the secret key with a public key in this certificate, it is possible to extract the hash value. Then, by comparing this hash value and a hash value of the actual catalog file, it is possible to certify validity of the catalog file, i.e. verify that the contents of each file in the driver set have not been altered. Further, there is a case where a printer driver is installed in an information processing apparatus, such as a personal computer (PC). In this case, depending on the signer of a digital signature attached to a catalog file, a confirmation screen for confirming whether or not to rely on this signer and perform the installation is sometimes displayed.

For example, as an operating system (OS) provided by Microsoft of the United States, there is known Windows (registered trademark). In this Windows, in a case where a printer driver having a CAT file signed by Microsoft is installed, display of a confirmation screen for prompting a user to confirm whether or not to perform this installation is omitted. On the other hand, there is also a case where a printer driver having a CAT file signed by a vendor other than Microsoft is installed. In this case, if a certificate used for this signature is not in a state relied on in a certificate store, a confirmation screen for prompting a user to confirm whether or not to rely on the signer and perform the installation is displayed.

In installation of a printer driver signed by a vendor, in a case where a certificate used for the signature is not in a state relied on in the certificate store of the OS, the confirmation screen for prompting a user to confirm whether or not to rely on the signer and perform the installation is displayed. Then, by installing the printer driver, the certificate used for the signature is disposed in a driver store as the certificate of the reliable issuer. With this, thereafter, if the printer driver is a printer driver signed by using the same certificate, redisplay of the confirmation screen is omitted when the printer driver is installed. Further, in general, an expiration date of the signature is set to a certificate used by a vendor with a signature. Therefore, in a case where the certificate has passed the expiration date, there is a possibility that it is impossible to sign by using the certificate. To prevent this, by newly acquiring a certificate used for the signature again from a certificate authority, the vendor can use the certificate having a new expiration date of the signature. This makes it possible to continuously perform signing.

Here, in a case where the certificate is newly acquired, this new certificate (hereinafter referred to as the “new certificate”) and the past certificate (hereinafter referred to as the “former certificate”) acquired before the new certificate are different from each other. Therefore, even if the signer of the new certificate and the signer of the former certificate are identical, when the printer driver is installed, it is determined by the OS that the new certificate and the former certificate, used for the signature, are different from each other. As a result, the confirmation screen for prompting a user to confirm whether or not to rely on the signer and perform the installation is displayed again. Let it be assumed, for example, that there is a case where a second printer driver is installed which is another printer driver with a signature signed by the same signer as the signer of a first printer driver which has been installed. In this case, although the user has already installed the first printer driver by relying on the signer, the confirmation screen is displayed again when the second printer driver is installed. This display of the confirmation screen can cause the user to feel troublesome or feel confused.

### SUMMARY

The present disclosure is directed to providing a mechanism that makes it possible to prevent, when a control driver is installed, a confirmation screen for prompting a user to confirm whether or not to perform the installation from being frequently displayed.

In a first aspect of the present disclosure, there is provided a non-transitory computer-readable storage medium storing a program for installing, in an information processing apparatus, a control driver that controls a peripheral device communicably connected to the information processing apparatus, the control driver having attached thereto a digital signature and certificate data that certifies validity of the digital signature, the program causing a computer of the information processing apparatus to execute a method comprising attaching a digital signature and certificate data that certifies validity of the digital signature to the control driver, acquiring the certificate data, determining whether or not the same certificate data as the certificate data acquired by the acquiring already exists in the information processing apparatus, determining whether or not a certificate having issuer information concerning the same issuer as an issuer which has issued the certificate data acquired by the acquiring already exists in the information processing apparatus, and inhibiting display of a confirmation screen for prompting a user to confirm whether or not to install the control driver in a case where it is determined that the same certificate data does not exist, and at the same time it is determined that a certificate having the issuer information exists, and displaying the confirmation screen in a case where it is determined that the same certificate data does not exist, and at the same time it is determined that a certificate having the issuer information does not exist.

In a second aspect of the present disclosure, there is provided a method of controlling installing, in an information processing apparatus, a control driver that controls a peripheral device communicably connected to the information processing apparatus, the control driver having attached thereto a digital signature and certificate data that certifies validity of the digital signature, the method comprising acquiring the certificate data, determining whether or not the same certificate data as the certificate data acquired by the acquiring already exists in the information processing apparatus, determining whether or not a certificate having issuer information concerning the same issuer as an issuer which has issued the certificate data acquired by the acquiring already exists in the information processing apparatus, and performing control to inhibit display of a confirmation screen for prompting a user to confirm whether or not to install the control driver in a case where it is determined that the same certificate data does not exist, and at the same time it is determined that a certificate having the issuer information exists, and display the confirmation screen in a case where it is determined that the same certificate data does not exist, and at the same time it is determined that a certificate having the issuer information does not exist.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram showing the entire configuration of a printing system according to a first embodiment.

FIG. 2 is a block diagram showing a hardware configuration of a computer appearing in FIG. 1.

FIG. 3 is a block diagram showing a software configuration of the computer.

FIG. 4 is a diagram showing a configuration of an installation set of a printer driver.

FIG. 5 is a diagram showing a transition state of screens displayed on a display section of the computer.

FIG. 6 is a diagram showing a screen displayed on the display section of the computer.

FIG. 7 is a flowchart of a process performed by an installer, for installing the printer driver into an OS.

FIG. 8 is a diagram showing a screen displayed on the display section of the computer during execution of the installer.

FIG. 9 is a flowchart of a process according to a second embodiment, performed by the installer, for installing the printer driver into the OS.

FIG. 10 is a diagram showing an example of an installation log.

### DESCRIPTION OF THE EMBODIMENTS

The present disclosure will now be described in detail below with reference to the accompanying drawings showing embodiments thereof. The configuration described in the following embodiments is given, only by way of example, and is by no means intended to limit the scope of the present disclosure. For example, components of the configuration of the present disclosure can be replaced with desired components which can exhibit the same functions. Further, desired components can be added. Further, two or more desired components (features) of the embodiments can be combined.

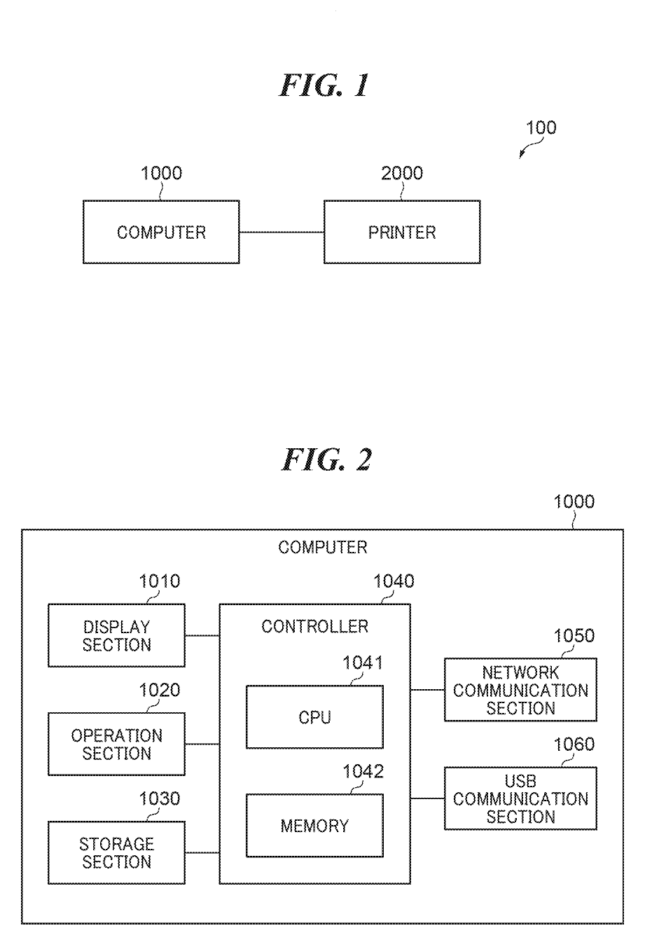

A first embodiment will be described below with reference to FIGS. 1 to 8. FIG. 1 is a schematic diagram showing the entire configuration of a printing system according to the first embodiment. As shown in FIG. 1, the printing system, denoted by reference numeral 100, includes a computer (information processing apparatus) 1000 and a printer 2000 as a peripheral device, and these are communicably connected to each other. Note that the connection method is not particularly limited, but, for example, can be a wired connection method or a wireless connection method. A print instruction to the printer 2000 is sometimes given from the computer 1000 to the printer 2000. In this case, a printer driver as a control driver for controlling the printer 2000 is required to have been installed in the computer 1000. This is because print data generated by an application of the computer 1000 is required to be mediated by the printer driver of the computer 1000 before being input to the printer 2000. Note that the application is not particularly limited, but a document generation application or a spreadsheet application, for example, can be used.

FIG. 2 is a block diagram showing a hardware configuration of the computer. As shown in FIG. 2, the computer 1000 includes a display section 1010, an operation section 1020, a storage section 1030, a controller 1040, a network communication section 1050, and a USB communication section 1060. The controller 1040 includes a central processing unit (CPU) 1041 and a memory 1042, and controls the overall operation of the computer 1000. The display section 1010 is formed e.g. by a liquid crystal display and displays a variety of information. The operation section 1020 includes, for example, a mouse, a keyboard, a touch panel, and so forth, and receives an instruction or the like from a user using the printing system 100. The storage section 1030 has a storage medium, such as a hard disk and an SSD (solid state drive), and stores a variety of software programs necessary for the operation of the computer 1000. Further, an operating system (OS) 1110, a printer driver, and so forth, described hereinafter, are also stored in the storage section 1030. The network communication section 1050 is connected to a network and enables communication between the same and a peripheral device, such as the printer 2000. The USB communication section 1060 enables communication between the same and the above-mentioned peripheral device by USB connection. The computer 1000 and the printer 2000 are connected via the network communication section 1050 or the USB connection section 1060. Note that the software processing in the present embodiment is realized by the CPU 1041 executing the software stored in the storage section 1030 and loaded into the memory 1042 of the controller 1040.

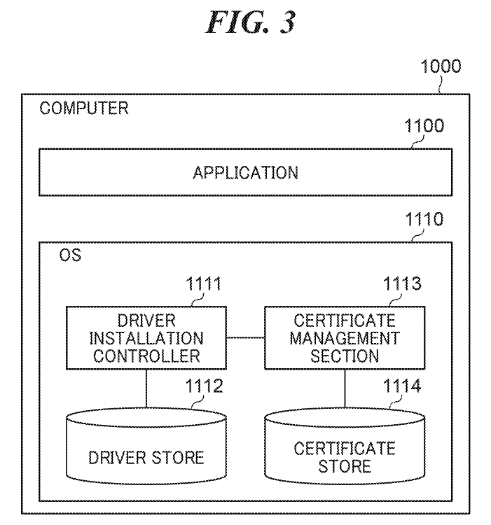

FIG. 3 is a block diagram showing a software configuration of the computer 1000. As shown in FIG. 3, the computer 1000 has an application 1100 and the OS 1110. These software items are stored in the storage section 1030 of the computer 1000. The applications are, for example, a document generation application, a spreadsheet application, and so forth. Note that an installer 1210, described hereinafter, is also included in the application 1100. The OS 1110 is software that controls basic operations of the computer 1000. The OS 1110 has a driver installation controller 1111, a driver store 1112, a certificate management section 1113, and a certificate store 1114. The driver installation controller 1111 performs control for installing a printer driver available outside the OS 1110 into the OS 1110. Here, the printer driver is software for controlling the printer 2000 from the computer 1000. In general, this printer driver is provided from a maker that manufactures the printer 2000 or a vendor that supplies the printer 2000. Further, “to install a printer driver into the OS 1110” refers to an operation of adding a printer driver provided from the maker or vendor to the OS 1110 to thereby enable the computer 1000 to use the printer 2000 under the control of the OS 1110. Further, the driver installation controller 1111 verifies a printer driver to be installed and stores the printer driver in the driver store 1112. In the driver store 1112, besides the printer driver, a variety of drivers for controlling peripheral devices are also stored. The certificate management section 1113 manages certificates (certificate data) registered in the OS 1110. The certificate store 1114 stores a variety of certificates managed by the certificate management section 1113 and used by the OS 1110. Here, the certificate refers to data that certifies validity of a digital signature. A public key is included in the certificate. By using the public key, it is possible to extract a hash value from a digital signature and certify that a printer driver (file), having the digital signature attached thereto, has not been altered. Information of the certificate is not particularly limited, but it can include, for example, an issuer of the certificate, version information of the certificate, a serial number of the certificate, the public key, and an expiration date of the certificate.

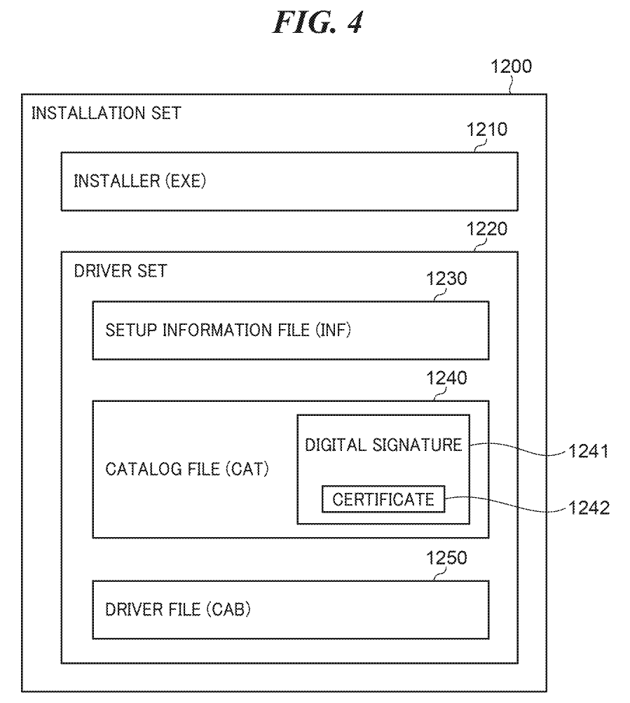

FIG. 4 is a diagram showing a configuration of an installation set of the printer driver. The installation set, denoted by reference numeral 1200, shown in FIG. 4 is provided from the maker or the vendor. The installation set 1200 is a file group including the installer (EXE) 1210 and a driver set 1220. The installer 1210 is a program for installing the printer driver and can cause the controller 1040 of the computer 1000 to execute steps (control method), described hereinafter. The driver set 1220 includes a setup information file (INF) 1230, a catalog file (CAT) 1240, and a driver file (CAB) 1250. The catalog file 1240 includes a digital signature 1241. The digital signature 1241 includes a certificate (certificate data) 1242. Note that although in the hierarchical configuration shown in FIG. 4, the certificate 1242 is included in the digital signature 1241, this is not limitative. For example, the digital signature 1241and the certificate 1242 can be parallel in hierarchy.

A user having the authority of the administrator is allowed to perform an operation of installing the driver file 1250. The driver file 1250 is a file generated by compressing the printer driver for controlling the printer 2000, a data file, and so forth. The setup information file 1230 includes information necessary for installing the driver file 1250. This information is not particularly limited, but includes, for example, a type of the printer driver, a version of the printer driver, a file name of the catalog file 1240, a file name of the driver file 1250, and an installation destination of the driver file 1250. The catalog file 1240 is used to verify the driver set 1220 when installing the driver file 1250. The catalog file 1240 is used for determination of whether or not the driver file 1250 has been altered.

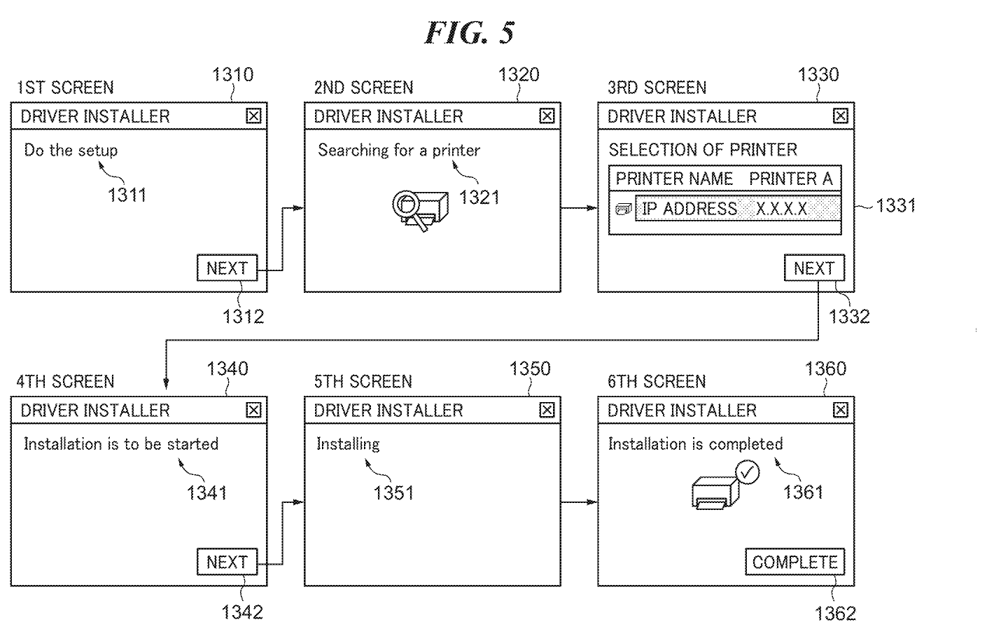

FIG. 5 is a diagram showing a transition state of screens displayed on the display section of the computer. Each screen shown in FIG. 5 is displayed by the installer 1210 of the installation set 1200, i.e. displayed when the installer 1210 of the installation set 1200 is executed. Further, here, a case where the installer 1210 is executed in a state in which the certificate 1242 has not been stored in the certificate store 1114 will be described. Referring to FIG. 5, on the display section 1010 of the computer 1000, a first screen 1310, a second screen 1320, a third screen 1330, a fourth screen 1340, a fifth screen 1350, and a sixth screen 1360 are sequentially displayed. The first screen 1310 is displayed when the installer 1210 is started. The first screen 1310 includes a message 1311 and a button 1312. The message 1311 is a message for prompting a user to install the printer driver. By pressing the button 1312, the second screen 1320 is displayed.

The second screen 1320 includes a message 1321. The message 1321 is a message to the effect that a printer, which is connected to the computer 1000 and is to be controlled by the printer driver to be installed, is being searched for. In a case where the printer is detected, the third screen 1330 is displayed. The third screen 1330 includes a list 1331 and a button 1332. On the list 1331, a name and an IP address of the printer obtained by printer detection are displayed in a list. The third screen 1330 in FIG. 5 shows, by way of example, a state in which a printer having a name of “Printer A” and an IP address of “X.X.X.X” is displayed in the list 1331, and this printer is selected. Note that it is assumed that this printer is the printer 2000. In this case, the printer driver to be installed is a printer driver that controls the printer 2000. Then, by pressing the button 1332 in a state in which the printer 2000 is selected, the fourth screen 1340 is displayed.

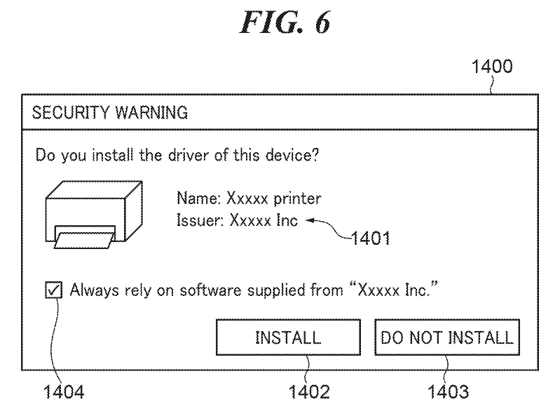

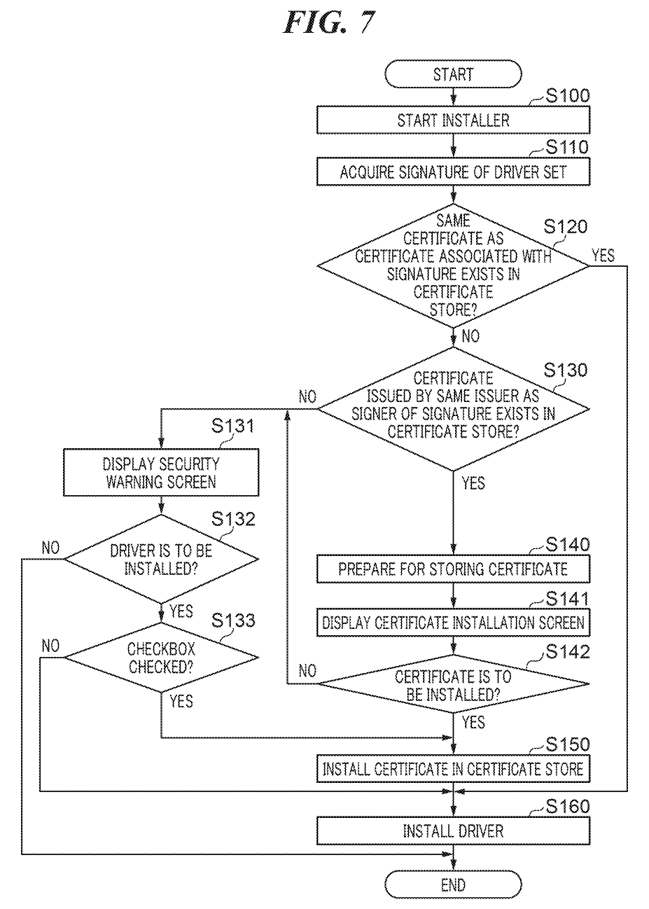

The fourth screen 1340 includes a message 1341 and a button 1342. The message 1341 is a message to the effect that installation of the printer driver that controls the printer 2000 is to be started. By pressing the button 1342, the fifth screen 1350 is displayed. The fifth screen 1350 includes a message 1351. The message 1351 is a message to the effect that installation of the printer driver is being executed. Installation of the printer driver is executed by the installer 1210 calling the API for driver installation, which is provided by the driver installation controller 1111 of the OS 1110. In doing this, the installer 1210 designates the setup information file 1230 in the driver set 1220. As described above, the certificate 1242 has not been stored in the certificate store 1114. Therefore, a security warning screen (confirmation screen) 1400 shown in FIG. 6 is displayed. Then, in a case where installation of the printer driver is completed, the sixth screen 1360 is displayed. The sixth screen 1360 includes a message 1361 and a button 1362. The message 1361 is a message to the effect that the installation is completed. By pressing the button 1362, the sixth screen 1360 is closed.

FIG. 6 is a diagram showing the screen displayed on the display section of the computer 1000. The security warning screen 1400 shown in FIG. 6 is displayed by the OS 1110 of the computer 1000 while the fifth screen 1350 is being displayed, i.e. during installation of the printer driver. In a case where the API for driver installation is called, the OS 1110 acquires the file name of the catalog file 1240 included in the setup information file 1230. Then, the OS 1110 refers to this catalog file 1240 and identifies the certificate 1242 associated with the digital signature 1241 included in the catalog file 1240. The OS 1110 displays the security warning screen 1400 in a case where this certificate 1242 does not exist in the certificate store 1114 of the OS 1110.

The security warning screen 1400 includes issuer information 1401, a button (instruction operation section) 1402, a button (cancel operation section) 1403, and a checkbox (selection section) 1404. The issuer information 1401 is information related to an issuer which has issued the digital signature 1241 and can be e.g. a maker name or a vendor name. With the button 1402, an operation of instructing installation of the printer driver is performed. By pressing (operating) the button 1402, the OS 1110 starts installation of the printer driver to which the digital signature 1241 of the issuer has been attached. On the other hand, with the button 1403, an operation of canceling installation of the printer driver is performed. By pressing the button 1403, the OS 1110 cancels installation of the printer driver. Thus, the security warning screen 1400 can prompt a user to confirm and determine whether or not to install the printer driver.

In the checkbox 1404, whether or not a user always relies on the printer driver to which the certificate 1242 of the same issuer as the digital signature 1241 has been attached is selected. In a case where the checkbox 1404 is checked, installation of a printer driver to which the certificate 1242 of the same issuer as the digital signature 1241 has been attached is always permitted. Then, in a case where the button 1402 is pressed in an ON-state in which the checkbox 1404 is checked, the OS 1110 stores (installs) the corresponding certificate 1242 in the certificate store 1114. Then, thereafter, there is a case where a printer driver is installed to which the same certificate 1242 as the certificate 1242 stored in the certificate store 1114 has been attached. In this case, the display of the security warning screen 1400 is inhibited. On the other hand, in a case where the button 1402 is pressed in an OFF-state in which the checkbox 1404 is not checked, the OS 1110 displays the security warning screen 1400 again when the printer driver to which the same certificate 1242 has been attached is installed. By displaying the security warning screen 1400 again, it is possible to prevent installation of a printer driver signed e.g. by a suspicious issuer. Note that in the present embodiment, installation of the printer driver is executed when the button 1402 is pressed in the ON-state in which the checkbox 1404 is checked.

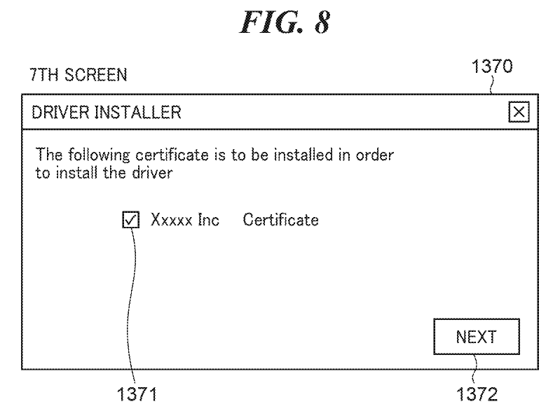

FIG. 7 is a flowchart of a process performed by the installer, for installing the printer driver into the OS. The installer 1210 is stored in the storage section 1030 of the computer 1000. The CPU 1041 executes the installer 1210 loaded into the memory 1042. FIG. 8 is a diagram showing a screen displayed on the display section of the computer during execution of the installer. Referring to FIG. 7, in a step S100, the installer 1210 (CPU 1041) starts upon receipt of a start instruction from a user using the computer 1000.

In a step S110, the installer 1210 acquires the digital signature 1241 from the catalog file 1240 of the driver set 1220. As mentioned above, the digital signature 1241 includes the certificate 1242. With this, in the step S110, the digital signature 1241 is acquired together with the certificate 1242.

In a step S120, the installer 1210 determines whether or not the certificate 1242 which is the same as the certificate 1242 acquired in the step S110 already exists in the computer 1000. Note that “the certificate 1242 already exists in the computer 1000” means that the certificate 1242 has been stored in the certificate store 1114 of the computer 1000. Further, in the present embodiment, the certificate 1242 acquired in the step S110 and the certificate 1242 which already exists in the computer 1000 each have a serial number attached thereto. The determination in the step S120 is performed based on whether or not the serial number of the certificate 1242 acquired in the step S110 and the serial number of the certificate 1242 which already exists in the computer 1000 are the same. Then, if it is determined in the step S120 that the same certificate 1242 already exists in the computer 1000, the process proceeds to a step S160. On the other hand, if it is determined in the step S120 that the same certificate 1242 does not exist in the computer 1000 yet, the process proceeds to a step S130.

In the step S130, the installer 1210 determines whether or not the certificate 1242 which has the issuer information concerning the same issuer as the issuer (signer) who has issued the certificate 1242 acquired in the step S110 already exists in the computer 1000. Note that the issuer (signer) of the digital signature 1241 coincides with the issuer of the certificate 1242 associated with this digital signature 1241. If it is determined in the step S130 that the certificate 1242 which has the issuer information already exists in the computer 1000, the process proceeds to a step S140. On the other hand, if it is determined in the step S130 that the certificate 1242 which has the issuer information does not exist in the computer 1000 yet, the process proceeds to a step S131.

In the step S131, the installer 1210 displays the security warning screen 1400 on the display section 1010.

In a step S132, the installer 1210 determines whether or not an operation of instructing installation of the printer driver has been performed by operating the button 1402 on the security warning screen 1400. If it is determined in the step S132 that the operation of instructing installation has been performed, the process proceeds to a step S133. On the other hand, if it is determined in the step S132 that the operation of instructing installation has not been performed, i.e. the button 1403 has been pressed, the present process is terminated.

In the step S133, the installer 1210 determines whether or not the checkbox 1404 is checked. If it is determined in the step S133 that the checkbox 1404 is checked, the process proceeds to a step S150. On the other hand, if it is determined in the step S133 that the checkbox 1404 is not checked, the process proceeds to the step S160.

In the step S140, the installer 1210 performs preparation for storing the certificate 1242 acquired in the step S110. That is, the installer 1210 determines the storage destination of the certificate 1242. In the present embodiment, the storage destination of the certificate 1242 is the certificate store 1114.

In a step S141, the installer 1210 displays a certificate installation screen (permission screen) 1370 shown in FIG. 8 on the display section 1010 (second display control step). The display timing of the certificate installation screen 1370 can be set, for example, to a timing between the third screen 1330 and the fourth screen 1340. The certificate installation screen 1370 is a screen for permitting installation of the certificate 1242 in the step S150, described hereinafter. The certificate installation screen 1370 includes a checkbox (selection section) 1371 and a button 1372. In the checkbox 1371, whether or not the user permits installation of the certificate 1242 in the step S150 is selected.

In a step S142, the installer 1210 determines whether or not the checkbox 1371 on the certificate installation screen 1370 is checked, i.e. whether or not the button 1372 has been pressed in a state in which the checkbox 1371 is checked. If it is determined in the step S142 that the checkbox 1371 is checked, the process proceeds to the step S150. On the other hand, if it is determined in the step S142 that the checkbox 1371 is not checked, the process proceeds to the step S131, and step S131 et seq. are sequentially executed.

In the step S150, the installer 1210 stores, i.e. installs the certificate 1242 acquired in the step S110 in the certificate store 1114 as the storage destination of the certificate 1242, which is determined in the step S140. Installation of the certificate 1242 is executed by the installer 1210 calling the API for certificate installation, which is provided by the certificate management section 1113 of the OS 1110.

In the step S160, the installer 1210 installs the printer driver. After execution of the step S160, the process is terminated.

As described above, if it is determined in the step S120 that the same certificate 1242 does not exist, and at the same time if it is determined in the step S130 that the certificate 1242 which has the issuer information does not exist, the security warning screen 1400 is displayed. On the other hand, if it is determined in the step S120 that the same certificate 1242 does not exist, and at the same time if it is determined in the step S130 that the certificate 1242 which has the issuer information exists, the display of the security warning screen 1400 is inhibited. With this control to display or not to display the security warning screen 1400, when a printer driver is installed, it is possible to prevent the security warning screen 1400 for prompting a user to confirm every time whether or not to perform this installation from being frequently displayed. Further, since the certificate 1242 is installed before installing the printer driver, it is possible to install the printer driver without displaying the security warning screen 1400.

Further, the installer 1210 displays the fourth screen 1340 after the certificate 1242 has been installed in the step S150. With this, for example, it is possible to prevent a user from installing the certificate 1242 against his/her will in a state in which the user does not grasp installation of the certificate 1242. Further, in a case where the button 1372 is pressed in a state in which the checkbox 1371 on the certificate installation screen 1370 is not checked, the installer 1210 omits installation of the certificate 1242 and displays the fourth screen 1340. In this case, the security warning screen 1400 is displayed.

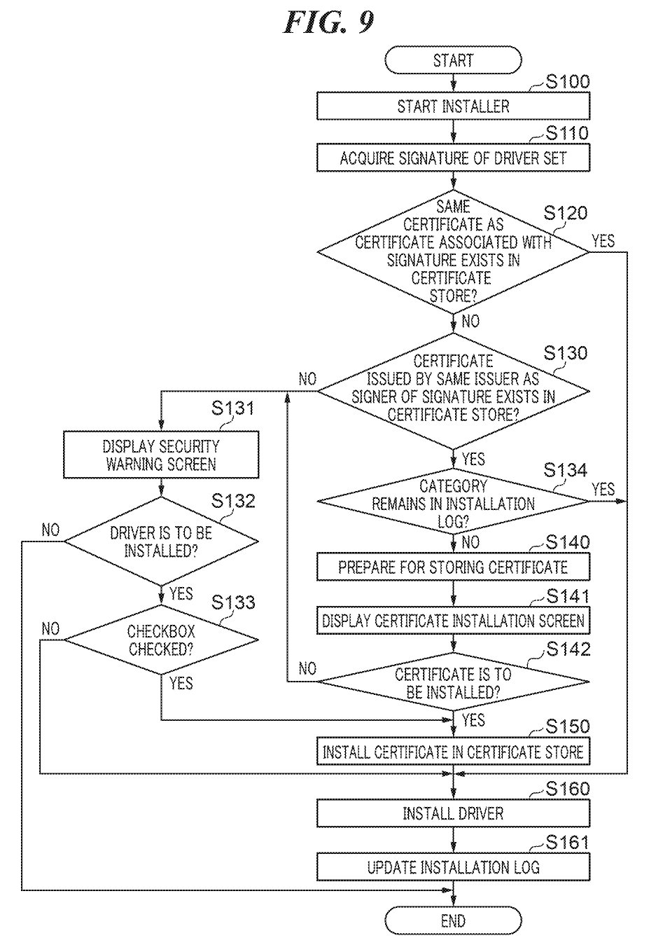

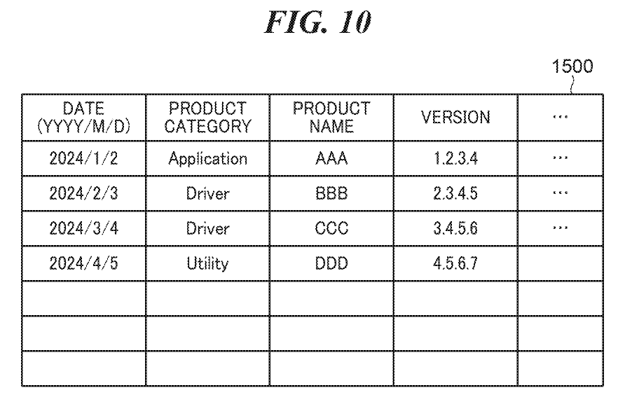

A second embodiment will be described below with reference to FIGS. 9 and 10, but the description will be given mainly of different points from the above-described embodiment, and description of the same points is omitted. In the first embodiment, in a case where the certificate 1242 of the same issuer as the signer of the printer driver exists in the certificate store 1114, the certificate 1242 is installed before installing the printer driver. With this, the display of the security warning screen 1400 is inhibited. Note that even in the case where the certificate 1242 of the same issuer as the signer of the printer driver exists in the certificate store 1114, there is a fear that it is difficult to determine whether or not the certificate 1242 is a certificate installed in accordance with installation of a printer driver. For example, there is a case where the signer of the printer driver provides not only the printer driver, but also a variety of software programs and services. Further, there is a case where a user desires to inhibit the display of the security warning screen 1400 in a case where the certificate 1242 has already been installed in the certificate store 1114 in accordance with installation of another printer driver or another version of the same printer driver. In the first embodiment, it is difficult to cope with this case. To cope with this, in the second embodiment, inhibition of the security warning screen 1400 is controlled based on the installation history of the software or service.

FIG. 9 is a flowchart of a process according to the second embodiment, performed by the installer1210, for installing the printer driver into the OS. The flowchart in FIG. 9 is different from the flowchart in FIG. 7 in that a step S134 is added between the step S130 and the step S140, and a step S161 is added after the step S160. For convenience of explanation, the process will be described from the step S161. FIG. 10 is a diagram showing an example of an installation log.

Referring to FIG. 9, in the step S161, the installer 1210 updates the record of installation in the storage section 1030 to generate an installation log 1500 shown in FIG. 10. Note that in a case where the installation log 1500 already exists, a record of installation is added to this installation log 1500. The installation log 1500 shown in FIG. 10 includes information, such as installation execution date and time, a product category, a product name, and a version.

Further, as shown in FIG. 9, in the step S134, the installer 1210 refers to the installation log 1500 and determines whether or not, for example, the product category remains in this installation log 1500. If it is determined in the step S134 that the product category remains, the process proceeds to the step S160. In this case, the condition for inhibiting the display of the security warning screen 1400 while a driver is being installed by the OS 1110 (non-display condition) is satisfied based on the information of the installation log 1500. Thus, the step S134 is processing for determining whether or not the non-display condition of the security warning screen 1400 is satisfied. Note that the non-display condition of the security warning screen 1400 can be included in the installer 1210 in advance or stored in the storage section 1030 in advance and acquired by the installer 1210 from the storage section 1030. On the other hand, if it is determined in the step S134 that the product category does not remain, the process proceeds to the step S140.

With the above-described configuration, it is possible to inhibit the display of the security warning screen 1400 in a case where the same printer driver has been installed in the past, for example. Further, it is also possible to inhibit the display of the security warning screen 1400 in a case where another printer driver was installed in the past. Further, it is also possible to inhibit the display of the security warning screen 1400 in a case where a printer driver of a version not lower or not higher than a predetermined version has been installed, or in a case where a printer driver has been or has not been installed within or outside a predetermined fixed time period.

Further, it is also possible to inhibit the display of the security warning screen 1400 in a case where a predetermined product has been or has not been installed in the past.

The peripheral device is the printer 2000 in the above-described embodiments but is not limited to this, and for example, a scanner can be used. In this case, the control driver is a scanner driver.

According to the present disclosure, it is possible to prevent, when a control driver is installed, frequent display of a confirmation screen for prompting a user to confirm whether or not to perform the installation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-024048, filed February 18, 2025, which is hereby incorporated by reference herein in its entirety.

What is claimed is:

1. A non-transitory computer-readable storage medium storing a program for installing, in an information processing apparatus, a control driver that controls a peripheral device communicably connected to the information processing apparatus, the control driver having attached thereto a digital signature and certificate data that certifies validity of the digital signature, the program causing a computer of the information processing apparatus to execute a method comprising:
attaching a digital signature and certificate data that certifies validity of the digital signature to the control driver;
acquiring the certificate data;
determining whether or not the same certificate data as the certificate data acquired by the acquiring already exists in the information processing apparatus;
determining whether or not a certificate having issuer information concerning the same issuer as an issuer which has issued the certificate data acquired by the acquiring already exists in the information processing apparatus; and
inhibiting display of a confirmation screen for prompting a user to confirm whether or not to install the control driver in a case where it is determined that the same certificate data does not exist, and at the same time it is determined that a certificate having the issuer information exists, and displaying the confirmation screen in a case where it is determined that the same certificate data does not exist, and at the same time it is determined that a certificate having the issuer information does not exist.

2. The non-transitory computer-readable storage medium according to claim 1, wherein the method further comprises installing the acquired certificate data in the information processing apparatus in a case where it is determined that a certificate having the issuer information exists.

3. The non-transitory computer-readable storage medium according to claim 2, wherein the method further comprises installing the control driver in a case where the certificate data has been installed.

4. The non-transitory computer-readable storage medium according to claim 2, wherein the method further comprises performing control to display a permission screen for permitting installation of the certificate at a timing between determination of whether or not the certificate already exists in the information processing apparatus and installation of the certificate.

5. The non-transitory computer-readable storage medium according to claim 4, wherein the permission screen includes a selection section for selecting whether or not to permit installation of the certificate.

6. The non-transitory computer-readable storage medium according to claim 4, wherein in a case where permission of installation of the certificate is selected by the selection section, installation of the certificate is executed.

7. The non-transitory computer-readable storage medium according to claim 6, wherein the method further comprises determining whether or not a condition for performing control not to display the confirmation screen is satisfied at a timing between the determination of whether or not the certificate already exists in the information processing apparatus and installation of the certificate.

8. The non-transitory computer-readable storage medium according to claim 1, wherein the certificate data acquired by the acquiring and certificate data which already exists in the information processing apparatus each have a serial number attached thereto, and
wherein the first-described determining is performed based on whether or not the serial number of the certificate data acquired by the acquiring and the serial number of the certificate data which already exists in the information processing apparatus are the same.

9. The non-transitory computer-readable storage medium according to claim 1, wherein the confirmation screen includes issuer information concerning an issuer which has issued the digital signature, an instruction operation section for performing an operation of instructing installation of the control driver, and a cancel operation section for performing an operation of canceling installation of the control driver.

10. The non-transitory computer-readable storage medium according to claim 1, wherein the confirmation screen includes a selection section for selecting whether or not to always permit installation of a control driver to which the same digital signature as the digital signature has been attached.

11. The non-transitory computer-readable storage medium according to claim 1, wherein the peripheral device is a printer, and
wherein the control driver is a printer driver that controls the printer.

12. A method of controlling installing, in an information processing apparatus, a control driver that controls a peripheral device communicably connected to the information processing apparatus, the control driver having attached thereto a digital signature and certificate data that certifies validity of the digital signature, the method comprising:
acquiring the certificate data;
determining whether or not the same certificate data as the certificate data acquired by the acquiring already exists in the information processing apparatus;
determining whether or not a certificate having issuer information concerning the same issuer as an issuer which has issued the certificate data acquired by the acquiring already exists in the information processing apparatus; and
performing control to inhibit display of a confirmation screen for prompting a user to confirm whether or not to install the control driver in a case where it is determined that the same certificate data does not exist, and at the same time it is determined that a certificate having the issuer information exists, and display the confirmation screen in a case where it is determined that the same certificate data does not exist, and at the same time it is determined that a certificate having the issuer information does not exist.

13. An information processing apparatus including a program for installing, in the information processing apparatus, a control driver that controls a peripheral device communicably connected to the information processing apparatus, the control driver having attached thereto a digital signature and certificate data that certifies validity of the digital signature, the information processing apparatus comprising:
the program causing a computer of the information processing apparatus to execute a method comprising:
acquiring the certificate data;
determining whether or not the same certificate data as the certificate data acquired by the acquiring already exists in the information processing apparatus;
determining whether or not a certificate having issuer information concerning the same issuer as an issuer which has issued the certificate data acquired by the acquiring already exists in the information processing apparatus; and
performing control to inhibit display of a confirmation screen for prompting a user to confirm whether or not to install the control driver in a case where it is determined that the same certificate data does not exist, and at the same time it is determined that a certificate having the issuer information exists, and display the confirmation screen in a case where it is determined that the same certificate data does not exist, and at the same time it is determined that a certificate having the issuer information does not exist.
